(19) United States
(12) Patent Application Publication
(10) Pub. No.: US 2023/0121939 A1
(43) Pub. Date: Apr. 20, 2023

(54) STRADDLE MOUNTED LOW PRESSURE COMPRESSOR

(71) Applicant: Raytheon Technologies Corporation, Farmington, CT (US)

(72) Inventor: Marc J. Muldoon, Marlborough, CT (US)

(21) Appl. No.: 17/504,869

(22) Filed: Oct. 19, 2021

(51) Int. Cl. F02K 3/06; F02C 3/107; F02C 7/36; F16H 1/28

(52) U.S. Cl. CPC F02K 3/06; F02C 3/107; F02C 7/36; F16H 1/2818; F05D 2220/323; F05D 2220/324; F05D 2220/325; F05D 2220/36; F05D 2260/40311

(57) ABSTRACT

A gas turbine engine includes a fan section including a fan with fan blades. The fan section drives air along a bypass flow path in a bypass duct. A gear reduction is in driving engagement with the fan. The gear reduction is a planetary gear system. A low spool includes a low pressure turbine that drives a low pressure compressor and drives the gear reduction to drive the fan at a speed slower than the low pressure turbine. A high spool includes a high pressure turbine that drives a high pressure compressor. A first low spool support bearing is located axially between the low pressure compressor and the gear reduction. A second low spool support bearing is located axially between the low pressure compressor and the high pressure compressor.

### BACKGROUND

A gas turbine engine typically includes a fan section, a compressor section, a combustor section, and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. The gas turbine engine can include a high spool having a high pressure turbine driving a high pressure compressor and a low spool having a low pressure turbine driving a low pressure compressor and the fan section.

### SUMMARY

In one exemplary embodiment, a gas turbine engine includes a fan section including a fan with fan blades. The fan section drives air along a bypass flow path in a bypass duct. A gear reduction is in driving engagement with the fan. The gear reduction is a planetary gear system. A low spool includes a low pressure turbine that drives a low pressure compressor and drives the gear reduction to drive the fan at a speed slower than the low pressure turbine. A high spool includes a high pressure turbine that drives a high pressure compressor. A first low spool support bearing is located axially between the low pressure compressor and the gear reduction. A second low spool support bearing is located axially between the low pressure compressor and the high pressure compressor.

In another embodiment according to any of the previous embodiments, the first low spool support bearing is supported by an engine static structure located axially forward of the low pressure compressor.

In another embodiment according to any of the previous embodiments, the engine static structure is located axially forward of the low pressure compressor is a front center body.

In another embodiment according to any of the previous embodiments, the second low spool support bearing is supported by an engine static structure located axially aft of the low pressure compressor.

In another embodiment according to any of the previous embodiments, the engine static structure is located axially aft of the low pressure compressor is an intermediate case.

In another embodiment according to any of the previous embodiments, the intermediate case at least partially defines a portion of a core flow path through the gas turbine engine fluidly downstream of the low pressure compressor and fluidly upstream of the high pressure compressor.

In another embodiment according to any of the previous embodiments, the intermediate case includes at least one structural support strut spanning the core flow path.

In another embodiment according to any of the previous embodiments, an inner race of the first low spool support bearing is configured to rotate with the low spool. An outer race of the first low spool support bearing is fixed to the front center body. An inner race of the second low spool support bearing is configured to rotate with the low spool. An outer race of the second low spool support bearing is fixed to the intermediate case.

In another embodiment according to any of the previous embodiments, a mid-turbine frame is located axially between the high pressure turbine and the low pressure turbine and supports an axially aft end of the high spool.

In another embodiment according to any of the previous embodiments, a pair of low spool support bearings is located axially aft of the low pressure turbine. The low spool is unsupported by the mid-turbine frame.

In another embodiment according to any of the previous embodiments, an aft end of the high spool is supported by a bearing system engaging a diffuser case.

In another embodiment according to any of the previous embodiments, the planetary gear set includes a ring gear fixed from rotating relative to the engine static structure. A sun gear is in driving engagement with an input from the low spool.

In another embodiment according to any of the previous embodiments, the fan section includes a fan drive shaft in driving engagement with the fan. A pair of fan shaft support bearing supports the fan drive shaft relative to the front center body. The gear reduction that includes a carrier in driving engagement with the fan drive shaft.

In another embodiment according to any of the previous embodiments, the low pressure compressor includes at least 4 stages and no more than 7 stages. The high pressure compressor includes more stages than the low pressure compressor.

In another embodiment according to any of the previous embodiments, the low pressure compressor includes at least 5 stages and no more than 7 stages. The high pressure compressor includes more stages than the low pressure compressor.

In another exemplary embodiment, a method of supporting a low pressure compressor section includes supporting a low pressure compressor on a low spool of a gas turbine engine with a first low spool support bearing located axially forward of the low pressure compressor and axially aft of a gear reduction. The gear reduction is in driving engagement with a fan section and is a planetary gear system. The low pressure compressor is supported with a second low spool support bearing located axially aft of the low pressure compressor.

In another embodiment according to any of the previous embodiments, the first low spool support bearing is supported by a front center body of an engine static structure located axially forward of the low pressure compressor. The second low spool support bearing is supported by an intermediate case of the engine static structure located axially aft of the low pressure compressor.

In another embodiment according to any of the previous embodiments, the low pressure compressor includes at least 4 stages and no more than 7 stages. A high pressure compressor on a high spool includes more stages than the low pressure compressor.

In another embodiment according to any of the previous embodiments, the low pressure compressor includes at least 5 stages and no more than 7 stages. A high pressure compressor on a high spool includes more stages than the low pressure compressor.

In another embodiment according to any of the previous embodiments, an aft end of a high spool is supported with support bearing supported by a mid-turbine frame located axially between a high pressure turbine and a low pressure turbine.

The present disclosure may include any one or more of the individual features disclosed above and/or below alone or in any combination thereof.

### BRIEF DESCRIPTION OF THE DRAWINGS

The various features and advantages of the present disclosure will become apparent to those skilled in the art from the following detailed description, The drawings that accompany the detailed description can be briefly described as follows.

FIG. 1 illustrates an example gas turbine engine.

FIG. 2 illustrates an example planetary gear system.

### DETAILED DESCRIPTION

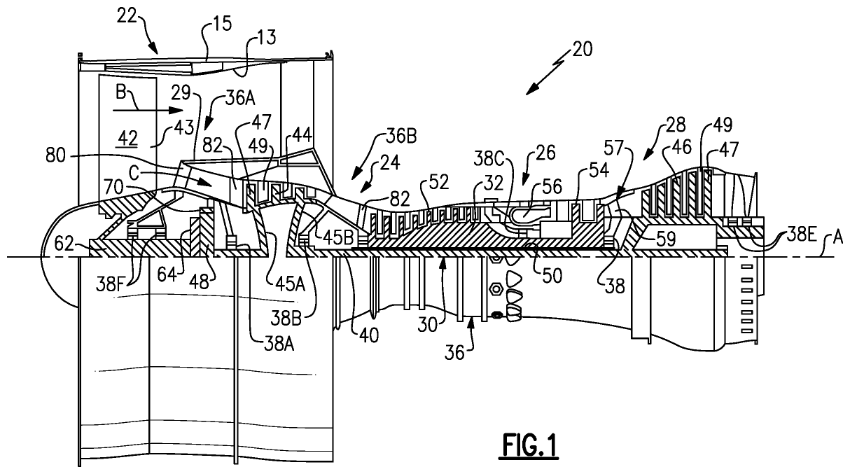

FIG. 1 schematically illustrates a gas turbine engine 20, The gas turbine engine 20 is disclosed herein as a two-spool turbofan that generally incorporates a fan section 22, a compressor section 24, a combustor section 26 and a turbine section 28, The fan section 22 may include a single-stage fan 42 having a plurality of fan blades 43. The fan blades 43 may have a fixed stagger angle or may have a variable pitch to direct incoming airflow from an engine inlet. The fan 42 drives air along a bypass flow path B in a bypass duct 13 defined within a housing 15 such as a fan case or nacelle, and also drives air along a core flow path C for compression and communication into the combustor section 26 then expansion through the turbine section 28. A splitter 29 aft of the fan 42 divides the air between the bypass flow path B and the core flow path C. The housing 15 may surround the fan 42 to establish an outer diameter of the bypass duct 13. The splitter 29 may establish an inner diameter of the bypass duct 13. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures. The engine 20 may incorporate a variable area nozzle for varying an exit area of the bypass flow path B and/or a thrust reverser for generating reverse thrust.

The exemplary engine 20 generally includes a low speed spool 30 and a high speed spool 32 mounted for rotation about an engine central longitudinal axis A relative to an engine static structure 36 via several bearing systems 38, It should be understood that various bearing systems 38 at various locations may alternatively or additionally be provided, and the location of bearing systems 38 may be varied as appropriate to the application.

The low speed spool 30 generally includes an inner shaft 40 that interconnects, a first (or low) pressure compressor 44 and a first (or low) pressure turbine 46, The inner shaft 40 is connected to the fan 42 through a speed change mechanism, which in the exemplary gas turbine engine 20 is illustrated as a geared architecture 48 to drive the fan 42 at a lower speed than the low speed spool 30. The inner shaft 40 may interconnect the low pressure compressor 44 and low pressure turbine 46 such that the low pressure compressor 44 and low pressure turbine 46 are rotatable at a common speed and in a common direction. In other embodiments, the low pressure turbine 46 drives both the fan 42 and low pressure compressor 44 through the geared architecture 48 such that the fan 42 and low pressure compressor 44 are rotatable at a common speed. Alternatively, the low pressure compressor 44 includes a forward hub 45A and an aft hub 45B driven by the inner shaft 40.

Although this application discloses geared architecture 48, its teaching may benefit direct drive engines having no geared architecture, The high speed spool 32 includes an outer shaft 50 that interconnects a second (or high) pressure compressor 52 and a second (or high) pressure turbine 54, A combustor 56 is arranged in the exemplary gas turbine 20 between the high pressure compressor 52 and the high pressure turbine 54, A mid-turbine frame 57 of the engine static structure 36 may be arranged generally between the high pressure turbine 54 and the low pressure turbine 46, The mid-turbine frame 57 further supports bearing systems 38 in the turbine section 28, In the illustrated example, the mid-turbine frame 57 only includes a bearing system 38 that supports the high spool 50 and the mid-turbine frame 57 does not support the low speed spool 30. Additionally, a pair of bearing systems 38E are located adjacent a downstream end of the low speed spool 30 adjacent an exhaust outlet of the gas turbine engine to support the low speed spool 30. Furthermore, a bearing assembly 38C can be located radially inward from the combustor 56 and supported by a diffuser case and be used in place of or in addition to the bearing system 38 associated with the mid-turbine frame 57. The inner shaft 40 and the outer shaft 50 are concentric and rotate via bearing systems 38 about the engine central longitudinal axis A which is collinear with their longitudinal axes.

Airflow in the core flow path C is compressed by the low pressure compressor 44 then the high pressure compressor 52, mixed and burned with fuel in the combustor 56, then expanded through the high pressure turbine 54 and low pressure turbine 46, The mid-turbine frame 57 includes airfoils 59 which are in the core flow path C, The turbines 46, 54 rotationally drive the respective low speed spool 30 and high speed spool 32 in response to the expansion, It will be appreciated that each of the positions of the fan section 22, compressor section 24, combustor section 26, turbine section 28, and fan drive gear system 48 may be varied, For example, gear system 48 may be located aft of the low pressure compressor, or aft of the combustor section 26 or even aft of turbine section 28, and fan 42 may be positioned forward or aft of the location of gear system 48.

The low pressure compressor 44, high pressure compressor 52, high pressure turbine 54 and low pressure turbine 46 each include one or more stages having a row of rotatable airfoils. Each stage may include a row of vanes adjacent the rotatable airfoils. The rotatable airfoils are schematically indicated at 47, and the vanes are schematically indicated at 49. In one example, the low pressure compressor 44 includes at least 4 stages and no more than 7 stages and in another example, the low pressure compressor 44 includes at least 5 stages and no more than 7 stages. In both examples, the high pressure compressor 52 includes more stages than the low pressure compressor.

The engine 20 may be a high-bypass geared aircraft engine. The bypass ratio can be greater than or equal to 10.0 and less than or equal to about 18.0, or more narrowly can be less than or equal to 16.0. The geared architecture 48 may be an epicyclic gear train, such as a planetary gear system or a star gear system. The epicyclic gear train may include a sun gear, a ring gear, a plurality of intermediate gears meshing with the sun gear and ring gear, and a carrier that supports the intermediate gears. With the planetary gear system, the ring gear is fixed from rotation relative to the engine static structure 36 and the carrier rotates with the fan 42. With the star gear system, the carrier is fixed from rotation relative to the engine static structure 36 and the ring gear rotates with the fan 42. The sun gear may provide an input to the gear train. The ring gear (e.g., star gear system) or carrier (e.g., planetary gear system) may provide an output of the gear train to drive the fan 42. A gear reduction ratio may be greater than or equal to 2.3, or more narrowly greater than or equal to 3.0, and in some embodiments the gear reduction ratio is greater than or equal to 3.4, The gear reduction ratio may be less than or equal to 4.2, The fan diameter is significantly larger than that of the low pressure compressor 44. The low pressure turbine 46 can have a pressure ratio that is greater than or equal to 8.0 and in some embodiments is greater than or equal to 10.0, The low pressure turbine pressure ratio can be less than or equal to 13.0, or more narrowly less than or equal to 12.0, Low pressure turbine 46 pressure ratio is pressure measured prior to an inlet of low pressure turbine 46 as related to the pressure at the outlet of the low pressure turbine 46 prior to an exhaust nozzle. It should be understood, however, that the above parameters are only exemplary of one embodiment of a geared architecture engine and that the present invention is applicable to other gas turbine engines including direct drive turbofans, All of these parameters are measured at the cruise condition described below.

A significant amount of thrust is provided by the bypass flow B due to the high bypass ratio, The fan section 22 of the engine 20 is designed for a particular flight condition—typically cruise at about 0.8 Mach and about 35,000 feet (10,668 meters), The flight condition of 0.8 Mach and 35,000 ft (10,668 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point, The engine parameters described above, and those in the next paragraph are measured at this condition unless otherwise specified.

“Fan pressure ratio” is the pressure ratio across the fan blade 43 alone, without a Fan Exit Guide Vane (“FEGV”) system, A distance is established in a radial direction between the inner and outer diameters of the bypass duct 13 at an axial position corresponding to a leading edge of the splitter 29 relative to the engine central longitudinal axis A. The fan pressure ratio is a spanwise average of the pressure ratios measured across the fan blade 43 alone over radial positions corresponding to the distance. The fan pressure ratio can be less than or equal to 1.45, or more narrowly greater than or equal to 1.25, such as between 1.30 and 1.40, “Corrected fan tip speed” is the actual fan tip speed in ft/sec divided by an industry standard temperature correction of [(Tram ° R)/(518.7° R)]° ⁵, The corrected fan tip speed can be less than or equal to 1150.0 ft/second (350.5 meters/second), and can be greater than or equal to 1000.0 ft/second (304.8 meters/second).

As shown in FIG. 1, the low speed spool 30 is supported by a number of bearing systems 38. In particular, an axially forward end of the low speed spool 30 adjacent the geared architecture 48 is supported by a first low spool support bearing 38A and a second low spool support bearing 38B. The first bearing 38A is located axially between the low pressure compressor 44 and the geared architecture 48. A location of attachment of the first bearing 38A with the low speed spool 30 is located axially upstream of a location of attachment of the low pressure compressor 44 to the low speed spool 30 and the location of engagement of the first bearing 38A is axially downstream of the geared architecture 48. Furthermore, a location of attachment of the second bearing 38B with the low speed spool 30 is located axially downstream of the location of attachment of the low pressure compressor 44 with low speed spool 30 and axially upstream of the high pressure compressor 52 and the high speed spool 32.

In this disclosure, axial and radial directions are in relation to the engine axis A unless stated otherwise. Additionally, axially upstream and downstream directions are in relation to a direction of flow of air through the core flow path C unless stated otherwise.

In the illustrated example, the first low spool support bearing 38A is supported by the engine static structure 36 located axially forward of the low pressure compressor 44. In the illustrated example, the first bearing 38A is supported by a front center body 36A of the engine static structure 36. An inner race of the first bearing 38A is configured to rotate with the low speed spool 30 and an outer race of the first bearing 38A is fixed relative to the front center body 36A. The front center body 36A provides structure support to a front of the gas turbine engine 20 forward of the low pressure compressor 44. The front center body 36A can include structural vanes and/or struts 80 that pass through the core flow path C upstream of the low pressure compressor 44.

In addition to supporting the first bearing 38A, the front center body 36A provides structural support for a pair of fan shaft support bearings 38F that support a fan drive shaft 62. The fan bearings 38F each include an inner race that is configured to rotate with the fan drive shaft 62 and an outer race fixed relative to the front center body 36A of the static structure 36. The fan drive shaft 62 is also in driving engagement with by an output of the geared architecture 48.

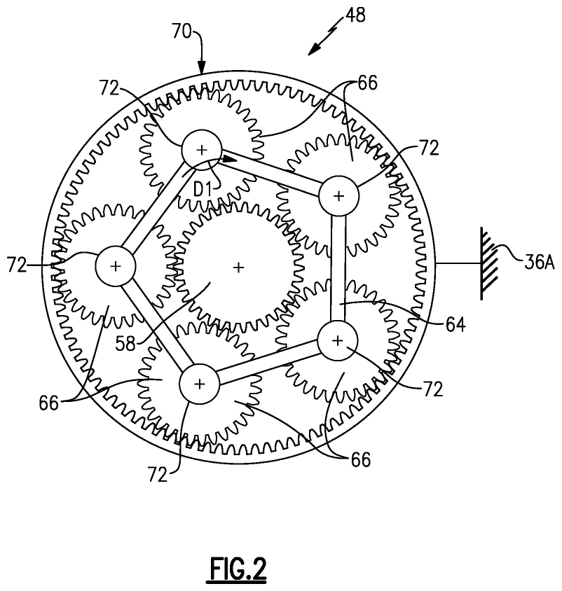

As shown in FIGS. 1-2, the geared architecture 48 provides an output through a carrier 64 that is configured to rotate with the fan drive shaft 62. The carrier 64 supports multiple planet gears 66 supported for rotation on bearings 72, such as journal bearings, relative to the carrier 64. The planet gears 66 also surround a sun gear 68 that is in driving engagement with the low pressure turbine 46 through the low speed spool 30. A ring gear 70 surrounds the planet gears 66 and is fixed from rotating relative to the front center body 36A of the engine static structure 36.

The second bearing 38B is supported by an intermediate case 36B of the engine static structure 36. The intermediate case is located axially aft of the low pressure compressor 44 and axially forward of the high pressure compressor 52 and the high speed spool 32. An inner race of the second bearing 38B is configured to rotate with the low speed spool 30 and an outer race of the second bearing 38B is fixed relative to the intermediate case 36B.

The intermediate case 36B at least partially define a boundary of the core flow path C fluidly downstream of the low pressure compressor 44 and upstream of the high pressure compressor 52. The intermediate case 36B also includes at least one structural support strut 82 radially spanning the core flow path C. The structure strut 80 can also be surrounded by an airfoil, such as an inlet guide vane, to turn air leaving the fan 42 and entering the core flow path C, A contour of the airfoil is determined based on a rotational direction of the fan 42 which determines a direction of movement of the air entering the core flow path C.

Although the different non-limiting examples are illustrated as having specific components, the examples of this disclosure are not limited to those particular combinations. It is possible to use some of the components or features from any of the non-limiting examples in combination with features or components from any of the other non-limiting examples.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claim should be studied to determine the true scope and content of this disclosure.

What is claimed is:

1. A gas turbine engine comprising:
a fan section including a fan with fan blades, wherein said fan section drives air along a bypass flow path in a bypass duct;
a gear reduction in driving engagement with the fan, wherein the gear reduction is a planetary gear system;
a low spool including a low pressure turbine driving a low pressure compressor and driving the gear reduction to drive the fan at a speed slower than the low pressure turbine;
a high spool including a high pressure turbine driving a high pressure compressor;
a first low spool support bearing located axially between the low pressure compressor and the gear reduction; and
a second low spool support bearing located axially between the low pressure compressor and the high pressure compressor.

2. The gas turbine engine of claim 1, wherein the first low spool support bearing is supported by an engine static structure located axially forward of the low pressure compressor.

3. The gas turbine engine of claim 2, wherein the engine static structure located axially forward of the low pressure compressor is a front center body.

4. The gas turbine engine of claim 3, wherein the second low spool support bearing is supported by an engine static structure located axially aft of the low pressure compressor.

5. The gas turbine engine of claim 4, wherein the engine static structure located axially aft of the low pressure compressor is an intermediate case.

6. The gas turbine engine of claim 5, wherein the intermediate case at least partially defines a portion of a core flow path through the gas turbine engine fluidly downstream of the low pressure compressor and fluidly upstream of the high pressure compressor.

7. The gas turbine engine of claim 6, wherein the intermediate case includes at least one structural support strut spanning the core flow path.

8. The gas turbine engine of claim 5, wherein an inner race of the first low spool support bearing is configured to rotate with the low spool, an outer race of the first low spool support bearing is fixed to the front center body, an inner race of the second low spool support bearing is configured to rotate with the low spool, and an outer race of the second low spool support bearing is fixed to the intermediate case.

9. The gas turbine engine of claim 8, including a mid-turbine frame located axially between the high pressure turbine and the low pressure turbine and supporting an axially aft end of the high spool.

10. The gas turbine engine of claim 9, including a pair of low spool support bearings located axially aft of the low pressure turbine, wherein the low spool is unsupported by the mid-turbine frame.

11. The gas turbine engine of claim 10, wherein an aft end of the high spool is supported by a bearing system engaging a diffuser case.

12. The gas turbine engine of claim 5, wherein the planetary gear set includes a ring gear fixed from rotating relative to the engine static structure and a sun gear in driving engagement with a input from the low spool.

13. The gas turbine engine of claim 12, wherein the fan section includes a fan drive shaft in driving engagement with the fan and a pair of fan shaft support bearing supporting the fan drive shaft relative to the front center body, the gear reduction includes a carrier in driving engagement with the fan drive shaft.

14. The gas turbine engine of claim 1, wherein the low pressure compressor includes at least 4 stages and no more than 7 stages and the high pressure compressor includes more stages than the low pressure compressor.

15. The gas turbine engine of claim 1, wherein the low pressure compressor includes at least 5 stages and no more than 7 stages and the high pressure compressor includes more stages than the low pressure compressor.

16. A method of supporting a low pressure compressor section, comprising:
supporting a low pressure compressor on a low spool of a gas turbine engine with a first low spool support bearing located axially forward of the low pressure compressor and axially aft of a gear reduction, wherein the gear reduction is in driving engagement with a fan section and is a planetary gear system; and
supporting the low pressure compressor with a second low spool support bearing located axially aft of the low pressure compressor.

17. The method of claim 16, wherein the first low spool support bearing is supported by a front center body of an engine static structure located axially forward of the low pressure compressor and the second low spool support bearing is supported by an intermediate case of the engine static structure located axially aft of the low pressure compressor.

18. The method of claim 16, wherein the low pressure compressor includes at least 4 stages and no more than 7 stages and a high pressure compressor on a high spool includes more stages than the low pressure compressor.

19. The method of claim 16, wherein the low pressure compressor includes at least 5 stages and no more than 7 stages and a high pressure compressor on a high spool includes more stages than the low pressure compressor.

20. The method of claim 16, including supporting an aft end of a high spool with support bearing supported by a mid-turbine frame located axially between a high pressure turbine and a low pressure turbine.
